(19) United States
(12) Patent Application Publication
(10) Pub. No.: US 2006/0212484 A1
(43) Pub. Date: Sep. 21, 2006

(54) System and method for evaluating, monitoring, diagnosing, and treating hypertension and other medical disorders

(76) Inventors: David Garvin Chaffin JR., Winfield, WV (US); Robert E. Mays, Huntington, WV (US); Clifford Harrison Webb, Milton, WV (US); Menashi A. Cohenford, Huntington, WV (US)

Correspondence Address: HOWARD & HOWARD ATTORNEYS, P.C., THE PINEHURST OFFICE CENTER, SUITE #101, 39400 WOODWARD AVENUE, BLOOMFIELD HILLS, MI, 48304-5151, US

(21) Appl. No.: 11/377,692

(22) Filed: Mar. 16, 2006

Related U.S. Application Data
(60) Provisional application No. 60/663,241, filed on Mar. 18, 2005.

(51) Int. Cl. G06F 7/00

(52) U.S. Cl. 707/104.1

(57) ABSTRACT

A system and method for treating hypertension and other medical disorders is provided. The system utilizes data collection devices for monitoring medical parameters of a plurality of patients and collecting data related to the medical parameters, and a centralized database for storing the collected data for each of the plurality of patients. Input devices are also used for transferring patient information such as name, family history, medications, weight, age, etc. to the database. The database correlates the collected data to the patient information for purposes of treatment and later retrieval by users to carry out research and other activities in which the collected data and patient information is useful. The system and method is particularly adapted for diagnosing and treating maternal hypertensive disorders such as preeclampsia and carrying out research related to understanding preeclampsia.

### RELATED APPLICATION

This application claims the benefit of U.S. provisional patent application Ser. No. 60/663,241, filed Mar. 18, 2005, the advantages and disclosure of which are hereby incorporated by reference in their entirety.

### FIELD OF THE INVENTION

The present invention generally relates to a system and method for evaluating, monitoring, diagnosing, and treating hypertension and other medical disorders.

### BACKGROUND OF THE INVENTION

Hypertension is a sustained elevation of blood pressure. Untreated, hypertension increases the risk for cardiac arrest, kidney failure, stroke, and other cardiovascular diseases. Hypertensive disorders, e.g., disorders in which hypertension is a factor, are particularly problematic in pregnant patients. Hypertension during pregnancy can harm a woman's kidneys and other organs, can result in low birth weight and early delivery, and can lead to preeclampsia. Preeclamspia is the second leading cause of maternal death in the United States and is the leading cause of fetal complications, including respiratory distress syndrome, cerebral palsy, blindness, epilepsy, deafness, lung conditions, and learning disabilities.

Currently, systems and methods are available for diagnosing hypertensive disorders. These prior art systems focus on the monitoring of hemodynamic parameters and the collection of hemodynamic data to assist a medical professional in the diagnosis and treatment of hypertensive disorders. Such a system is shown in U.S. Pat. No. 5,054,493 to Cohn et al. and U.S. Pat. No. 5,836,884 to Chio. While these systems meet certain objectives, the aforementioned patents do not disclose a system that enables medical professionals to select the most effective and appropriate treatment for maternal hypertension, or hypertension generally, nor do these prior art systems incorporate advances in telecommunication and networking technologies necessary to build an infrastructure that can enable more effective and efficient evaluation, monitoring, diagnosis, and treatment of such disorders.

Diagnosis of preeclampsia has also been advanced using a variety of analytical methods. For instance, U.S. Pat. No. 5,238,819 to Roberts et al. suggests that preeclampsia can be diagnosed using an assay to measure a mitogenic factor in blood. Other factors or variables are also known to improve preeclampsia diagnosis including M-CSF concentration (see U.S. Pat. No. 5,543,138), a hemoglobin variant and RBC glycolytic enzyme (see U.S. Pat. No. 5,849,474), neutrophil defensins (see U.S. Pat. No. 5,972,594), glycerophosphatidyl compounds (see U.S. Pat. No. 6,461,830), fetal syncytin concentration (see U.S. Patent Application Publication No. 2002/0102530), and a polynucleotide sequence (see U.S. Patent Application Publication No. 2005/0255114).

Preeclampsia prediction has also been improved by factors such as albumin pI5.6 concentration (see U.S. Pat. No. 6,642,055), insulin-like growth factor binding protein-1 (IGFBP-1) (see U.S. Pat. No. 5,712,103), and a serum cellular proliferation assay (see U.S. Patent Application Publication No. 2005/0074746). None of these factors alone, however, provide absolute predictive and diagnostic results with respect to predicting and diagnosing preeclampsia. As a result, research is continuing to define other contributing factors.

Therefore, there is a need in the art for systems and methods for the effective and efficient evaluation, monitoring, diagnosis, and treatment of hypertensive disorders, including preeclampsia and maternal hypertension to further advance the prediction, diagnosis, and treatment of such hypertensive disorders.

### SUMMARY OF THE INVENTION AND ADVANTAGES

The present invention provides a system for treating a medical disorder such as hypertension. The system comprises a data collection device for monitoring at least one medical parameter of a patient and collecting data related to the at least one medical parameter of the patient. A database stores the collected data for later retrieval. An input device is in communication with the database to transfer patient information of the patient to the database. The database then correlates the collected data to the patient information of the patient for purposes of treating the patient. A reporting module is in communication with the database to retrieve at least a predefined subset of the collected data and the patient information and automatically determine a treatment for the medical disorder based on the predefined subset.

In one aspect of the invention, the database is a relational database that is capable of being integrated with statistical software programs for refining the best treatment by determining relationships existing in the predefined subsets of the collected data and the patient information. It is understood by one skilled in the art that the best treatment may include listing alternate treatments to allow for doctor preference(s) and patient choice(s).

The present invention also provides a method for treating medical disorders. The method includes monitoring the at least one medical parameter of the patient and collecting the data related to the at least one monitored medical parameter. The method also includes storing the collected data in the database and transferring the patient information to the database. The database correlates the collected data to the transferred patient information. The method then includes retrieving the predefined subset of the collected data and the transferred patient information and automatically determines a treatment based on the retrieved subset.

In one aspect of the invention, the method is capable of incorporating statistical software programs to automatically redefine a treatment based on discovery of relationships existing in the predefined subsets of the collected data and the patient information.

One advantage of the system and method of the present invention is that by automatically determining the treatment for the patient, treatment for hypertensive disorders can be improved. Also, by storing the collected data and the patient information in the database, users such as researchers and the like can remotely retrieve at least portions of the collected data and the patient information for purposes of review and analysis. Analysis may include incorporating statistical software programs to evaluate at least portions of the collected data and the patient information.

### BRIEF DESCRIPTION OF THE SEVERAL VIEWS OF THE DRAWINGS

Advantages of the present invention will be readily appreciated as the same becomes better understood by reference to the following detailed description when considered in connection with the accompanying drawings wherein:

FIG. 1 is a flow diagram illustrating the flow of data in a system for treating hypertension and other medical disorders in accordance with one embodiment of the present invention;

FIG. 2 is a schematic view of one embodiment of the system;

FIG. 3 is an illustration of sensors connected to a patient;

FIG. 4 is a process flow diagram illustrating a method of using the system during a patient session in accordance with one embodiment of the present invention;

FIG. 5 is an illustration of a patient information form provided by the system for entering patient information into a database;

FIG. 6 is an illustration of a first data collection form provided by the system for initiating data collection;

FIG. 7 is an illustration of a second data collection form provided by the system to review the collected data in real-time;

FIG. 8 is an illustration of a third data collection form provided by the system to stop data collection;

FIG. 9 is an illustration of a fourth data collection form provided by the system to review the collected data once data collection has stopped;

FIG. 10 is an illustration of a sample session summary produced by the system; and

FIG. 11 is a graphical representation of a hypertension treatment matrix used to automatically determine treatment for the patient.

### DESCRIPTION OF THE INVENTION

Referring to the Figures, wherein like numerals indicate like or corresponding parts throughout the several views, a system 100 for evaluating, monitoring, diagnosing, and treating hypertensive disorders, such as maternal hypertension and preeclampsia, is generally shown at 100.

For purposes of description, the terms diagnosis or diagnosing are generally defined broadly to include, but not be limited to, susceptibility, risk prediction, exclusion, and monitoring of or for a diseased state, and includes distinguishing one disease from another including minor variations based on signs, symptoms, laboratory findings and the like. Likewise, the terms treat, treatment, or treating are defined broadly to include, but not be limited to, prevention of a diseased state.

The System 100

While the system 100 is described with specific reference to the diagnosis and treatment of hypertensive disorders, it should be appreciated by those skilled in the art that the system 100 is generally applicable to diagnosis and treatment of other diseases or medical disorders. In addition, it should be apparent to those skilled in the art that patients are examined and/or treated by many medical professionals including, for example, physicians, nurses, nurse practitioners, medical assistants, medical consultants, and the like. Also, non-medically trained personnel may be involved in the examination and treatment of the patients. For purposes of description, reference is generally made to medical professionals.

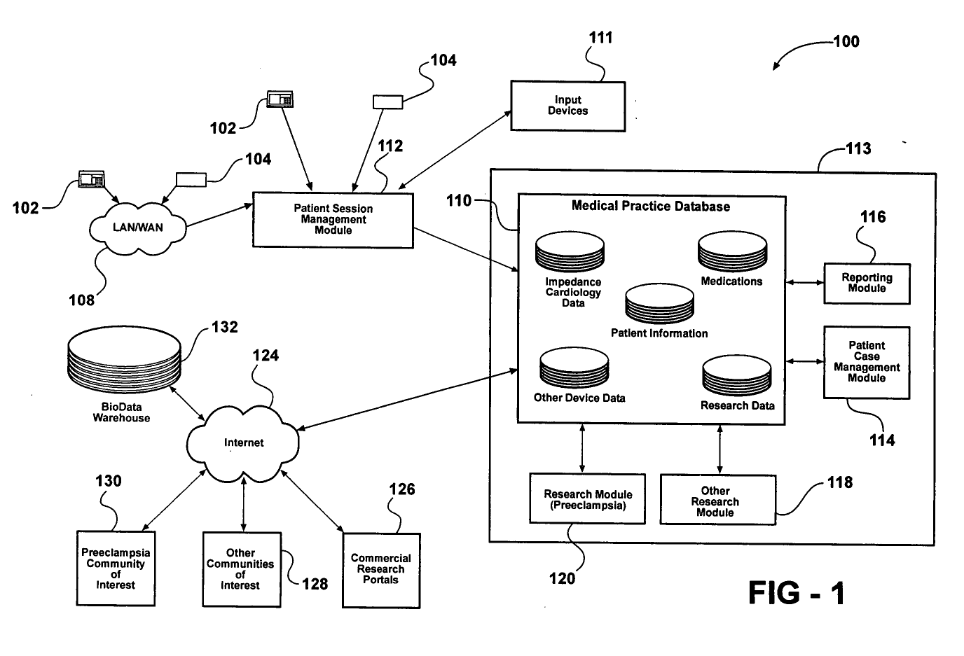

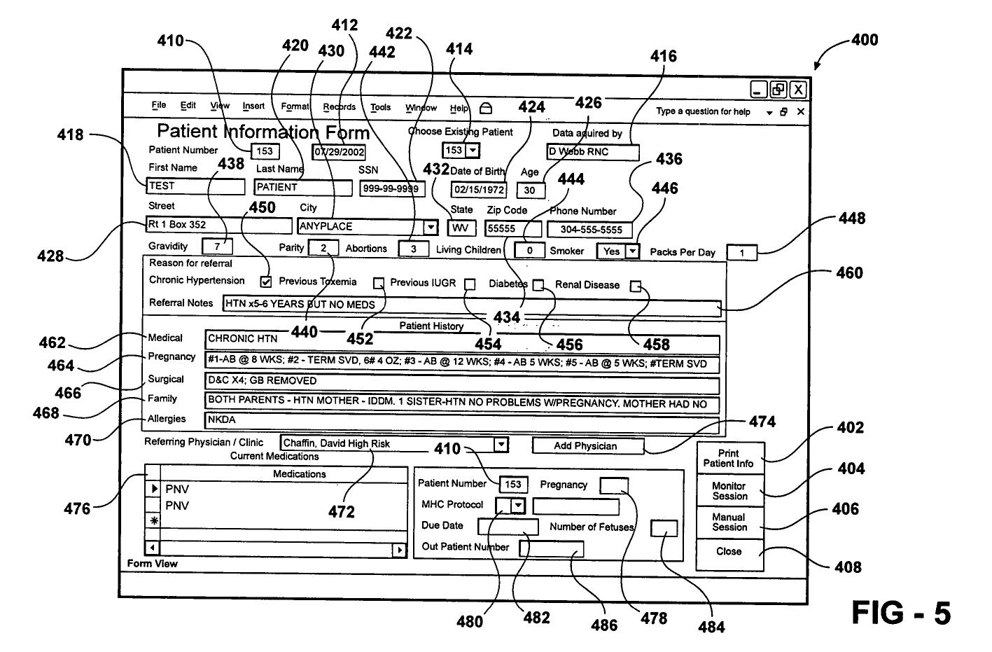

Referring to FIG. 1, for new or untreated patients, the system 100 first acquires patient information during a session between the patient and a medical professional. Preferably, the system 100 acquires the patient information by having a medical professional transfer the patient information of the patient into a medical practice relational database 110. The medical professional preferably utilizes one or more input devices 111 such as a keyboard and/or mouse to enter the patient information into the database 110 through a patient information form 400 provided by a patient session management module 112 of the database 110 (see FIG. 5). Such forms are well known to those skilled in the art and will not be described in detail.

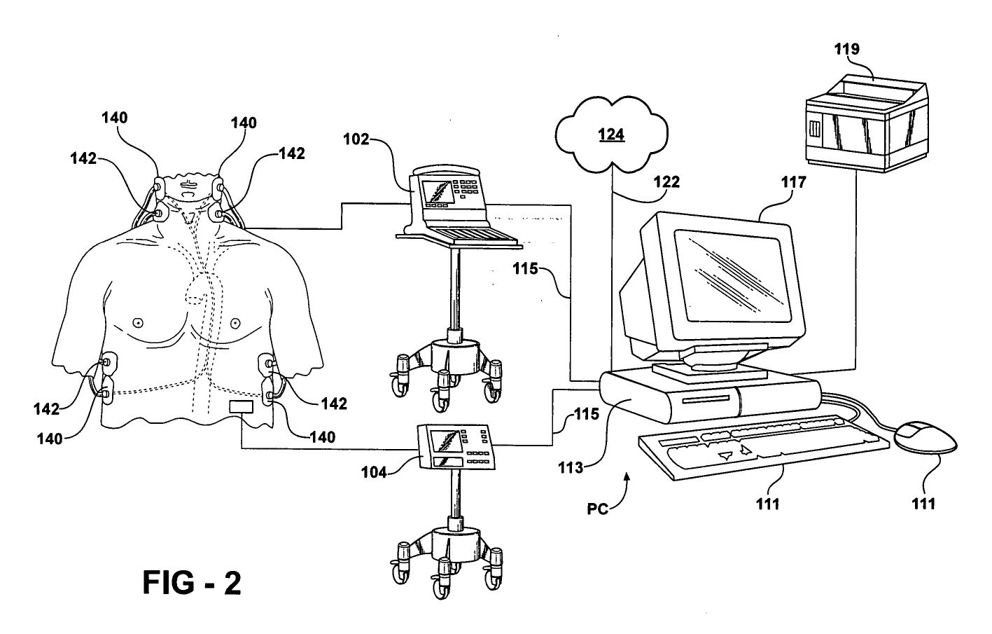

The database 110 is stored on a database computer 113. The database computer 113 may be a personal computer or one or more servers. In one embodiment, shown in FIG. 2, two input devices 111 are connected to a personal computer PC and the personal computer PC operates as the database computer 113 to store and operate the database 110 such that the input devices 111 are in communication with the database 110. The system 100 provides a suitable graphical user interface (see FIGS. 5-9) and software operating on the personal computer PC for this purpose. The personal computer PC includes a Microsoft® Windows operating system running Microsoft® Access as the relational database management system and includes, at a minimum, a CPU, sufficient RAM memory and hard drive memory to store and operate Microsoft® Windows and Microsoft® Access. It should be appreciated that any commercially available operating system such as Linux® or MacOS® and any commercially available relational database management system such as Microsoft® SQL could also be used. Reporting devices, including a display 117 and a printer 119, are also electronically coupled to the personal computer PC through wired or wireless connections. In alternative embodiments, the personal computer PC may be in communication with the database computer 113 by wired or wireless local area networks (LANs), wide area networks (WANs), the Internet, or other networks to enter the patient information in the database 110 from the personal computer PC.

Acquired patient information may include, for example, patient name, address, age, sex, weight, height, medical/surgical history, family medical history, prescribed medications, basis for referral, allergies, pregnancy/birth history, referring physician data, clinic information, abortion history, information about living children, smoking history, pain scale information, and a patient identification number. Additional patient information may also include data regarding chronic hypertension, toxemia, IUGR, diabetes, renal disease, past treatment regimens, patient environmental and demographic data, and appointment information. It is understood by one skilled in the art that as biomarker detection methods become more available these may be included as additional patient information. For example, as genetic testing becomes available, those patients having the genetic variant of Transcription Factor 7-Like 2 (TCF7L2) can be reported since this genetic variant is carried by more than one third of the American population and confers a much greater risk of type 2 diabetes (Grant S F, et al, 2006). It would be evident to one skilled in the art that the system 100 may incorporate data entry verification and error detection mechanisms to ensure accurate and complete entry of manually entered patient information.

The evaluation and treatment of a hypertensive patient will often comprise a series of visits by the patient. The patient information is updated during each patient session. Ultimately, the database 110 is updated and populated with updated patient information corresponding to each patient visit via the patient session management module 112.

Once the patient information is acquired, the system 100 collects medical data from the patient. Preferably, the system 100 acquires medical data relating to medical parameters such as the patient's Systolic Blood Pressure (SBP), Diastolic Blood Pressure (DBP), Mean Arterial Pressure (MAP), Cardiac Output (CO) and Systemic Vascular Resistance (SVR). A data collection device 102 is utilized to collect the medical data. In one embodiment, the medical data is hemodynamic data (e.g., SBP, DBP, MAP, CO, SVR, etc.) obtained from a hemodynamic monitor such as an impedance cardiology device 102 that is in communication with the database 110 via the patient session management module 112 to automatically populate the appropriate fields in the database 110. The database 110 correlates the patient information transferred to the database 110 with the medical data collected by the impedance cardiology device 102.

In the preferred embodiment, the impedance cardiology device 102 is a BioZ® ICG Monitor manufactured by CardioDynamics of San Diego, Calif., which provides non-invasive, continuous data measurements of the following hemodynamic parameters:
Stroke Volume/Stroke Index (SV/SI);
Cardiac Output/Cardiac Index (CO/CI);
Systemic Vascular Resistance/SVR Index (SVR/SVRI);
Velocity Index (VI);
Acceleration Index (ACI);
Pre-Ejection Period (PEP);
Left Ventricular Ejection Time (LVET);
Systolic Time Ratio (STR);
Thoracic Fluid Content (TFC); and
Left Cardiac Work/LCW Index (LCW/LCWI).

For the purposes herein and as would be obvious to one skilled in the art, the following hemodynamic parameters are defined as:

Stroke Volume/Stroke Index (SV/SI): Stroke Volume (SV) is the amount of blood the left ventricle ejects in one beat, measured in milliliters per beat (ml/beat). SV can be indexed to a patient's body size by dividing by Body Surface Area (BSA) to yield Stroke Index (SI).

Cardiac Output/Cardiac Index (CO/CI): Cardiac Output (CO) is the amount of blood the left ventricle ejects into the systemic circulation in one minute, measured in liters per minute (1/min). CO is Stroke Volume (SV) multiplied by Heart Rate (FIR). CO can be indexed to a patient's body size by dividing by Body Surface Area (BSA) to yield Cardiac Index (CI).

Systemic Vascular Resistance/SVR Index (SVR/SVRI): Systemic Vascular Resistance (SVR) is representative of the force that the left heart must pump against in order to deliver the stroke volume into the periphery. SVR is directly proportional to blood pressure and indirectly proportional to blood flow (CO). SVR is determined by the following equation: SVR=[(MAP−CVP)/CO]×80. SVR can be indexed to a patient's body size by substituting Cardiac Index for Cardiac Output to yield Systemic Vascular Resistance Index (SVRI). SVRI=[(MAP−CVP)/CI]×80.

Velocity Index (VI) and Acceleration Index (ACI): These two indices are both BioZ® specific parameters. VI is the maximum rate of impedance change, and is representative of aortic blood velocity. ACI is the maximum rate of change of blood velocity and representative of aortic blood acceleration. They reflect cardiac contractility or the pumping force of the heart.

Pre-Ejection Period (PEP): PEP is the measured interval from the onset of ventricular depolarization (Q-wave in an ECG) to the beginning of the opening of the aortic valve (first upslope of the impedance waveform, B point).

Left Ventricular Ejection Time (LVET): LVET is the time from aortic valve opening (B point on the impedance waveform) to aortic valve closing (X point on the impedance waveform).

Systolic Time Ratio (STR): STR is inversely proportional to left ventricular function, and is calculated as the Pre-Ejection Period (PEP) divided by the Left Ventricular Ejection Time (LVET), STR=PEP/LVET

Thoracic Fluid Content (TFC): TFC is a BioZ® specific parameter that is representative of total fluid volume in the chest, comprised of both intia-vascular and extra-vascular fluid. TFC is calculated as the inverse of the baseline impedance measurement. Baseline impedance is directly proportional to the amount of conductive material (i.e. blood, lung water) in the chest.

Left Cardiac Work/Left Cardiac Work Index (LCW/LCWI): LCW parallels myocardial oxygen consumption, and is the product of blood pressure and blood flow. LCW is determined with the following equation: LCW=(MAP−PAOP)×CO×0.0144.

PAOP is Pulmonary Artery Occluded Pressure, or wedge pressure. Outside of direct measurement with a Pulmonary Artery Catheter, a default value of 12 mm Hg can be used because of PAOP's minimal effect on LCW determination.

LCW can be indexed to a patient's body size by substituting Cardiac Index for Cardiac Output to yield Left Cardiac Work Index (LCWI) LCWI=(MAP−PAOP)×CI×0.0144. Mean Arterial Pressure (MAP) is the average pressure exerted by the blood on the arterial walls.

In the preferred embodiment, the impedance cardiology device 102 takes continuous readings of the hemodynamic parameters of the patient. These readings are associated with the patient by being correlated to the patient information in the database 110 such as by a patient identification number, patient name, or other common identifier. In the preferred embodiment, a commercial software application such as WedgeLink™ is used to translate and feed the data stream of the impedance cardiology device 102 into a format that is readily captured by the database 110. The hemodynamic data that is acquired is then plotted on a hypertension treatment matrix 300 to guide a medical professional in prescribing medication to pharmacologically treat the patient. The system 100 may also acquire medical data from other data collection device(s) 104 other than or in addition to the impedance cardiology devices 102, where all medical data generated by the devices 102, 104 is correlated to the patient information to ultimately populate the database 110. The other data collection devices 104 may measure parameters such as blood oxygen, respiration via transthoracic impedance, body temperature, and the like.

Referring specifically to FIG. 2, in one embodiment, the system 100 includes a communication link 115 coupling the database computer 113 to the impedance cardiology device 102 enabling data collection and management of the hemodynamic data generated by the impedance cardiology device 102. The hemodynamic data related to each hemodynamic parameter is collected, translated, and stored in the database 110 corresponding to each patient. In one embodiment, the communication link 115 is a direct serial port connection (e.g. RS-232). In other embodiments, the communication link 115 is a wireless connection, e.g., WiFi, infrared, etc. The communication link 115 may also include a network connection to local area networks/wide area networks 108 (LAN/WAN) including wired or wireless network links providing communication between the impedance cardiology device 102 and the database 110 and between other data collection device(s) 104 and the database 110.

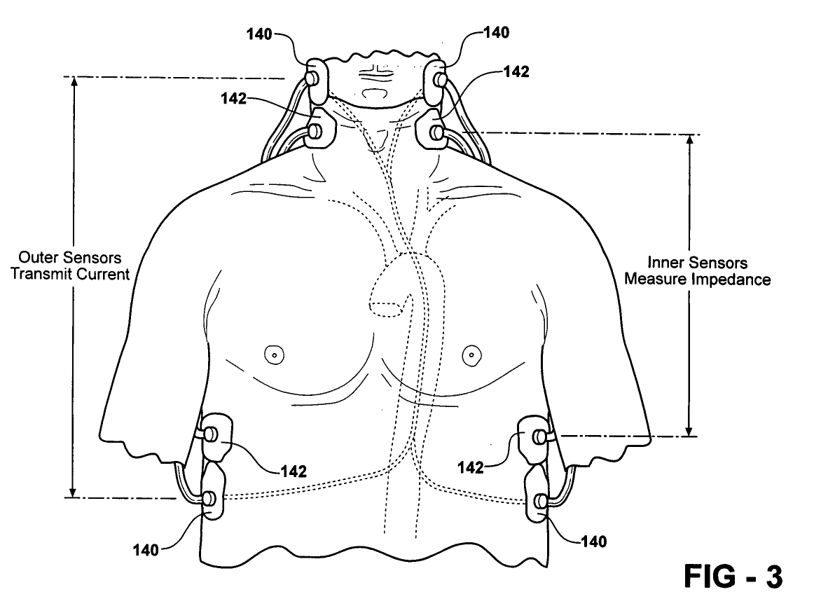

Referring briefly to FIG. 3, the patient is connected to the impedance cardiology device 102 according to the device's specifications. Preferably, the impedance cardiology device 102 uses non-invasive outer sensors 140 placed on the patient to transmit current and non-invasive inner sensors 142 placed on the patient to measure impedance. It should be appreciated that an impedance cardiology device 102 other than a BioZ® device could also be utilized.

The present invention provides for the selection, translation, sequencing, and identification of the medical data obtained from the impedance cardiology device 102 or other data collection device(s) 104. The system 100 associates or correlates all medical data acquired by the system 100 with the patient information for each patient session. The medical data acquired by the system 100 is checked to remove incomplete data segments that might interfere with further analysis before it populates the database 110. This process is described further below.

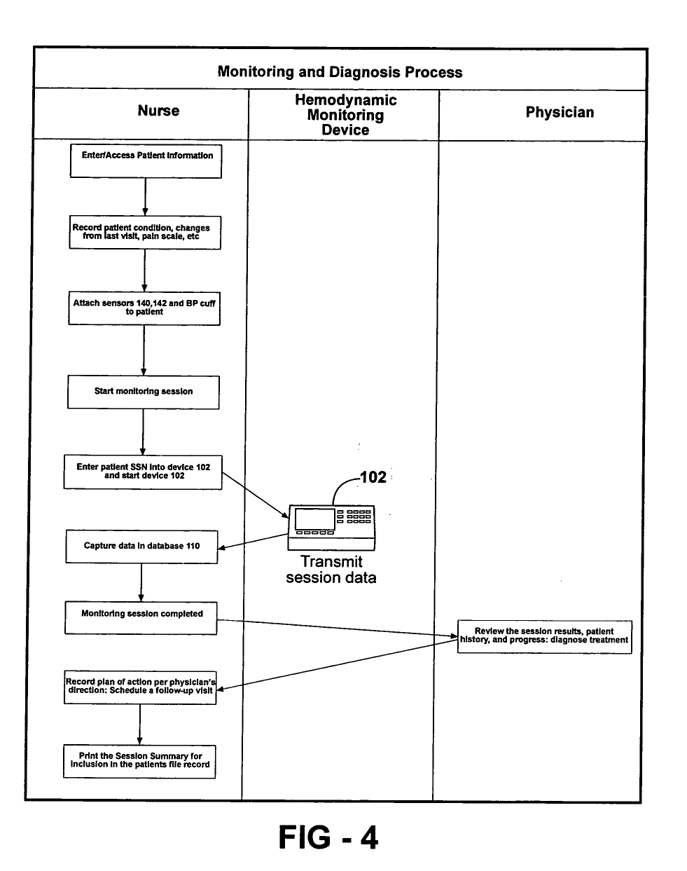

The processes of acquiring patient information and acquiring hemodynamic or other medical data from the impedance cardiology device 102 or other data collection device(s) 104 for a patient during an office session are continuously performed during treatment of a patient during each patient management session using the patient session management module 112. A sample flow diagram of a patient session is shown in FIG. 4.

All medical data and patient information acquired by the system 100 is captured and stored in the database 110. Additionally, the database 110 comprises research data acquired from such resources as independent medical research studies which are input into the system 100 by a user to provide a more detailed and comprehensive database 110. The system 100 provides for the selection, translation, sequencing, and identification of all data, e.g., medical data, patient information, research data, etc., such that it can be immediately viewed, printed, and associated or compared with other data items, including for example, patient information like medical history and treatment regimes can be compared with the hemodynamic data from the impedance cardiology device 102, as well as other combinations of user selected data.

Further, the system 100 improves the treatment of a hypertensive patient by generating real-time reports permitting a medical professional to study the relationships of all data acquired by the system 100 about a specific patient as part of a patient case management module 114, including for example, hemodynamic data, patient history, treatment regimens, prior and current medication prescriptions, and other medical, environmental, or health factors. The patient case management module 114 also provides office appointment scheduling.

Research Modules 118, 120

Referring back to FIG. 1, from the data stored in the database 110, focused data modules may be created by a user of the system 100 to retrieve and review specific relationships to aid in treatment of hypertensive disorders. For example, modules for preeclampsia 120 as well as other research modules 118 may be created by a user to comprise specific data fields relative to preeclampsia or other focused medical disorders. The modules for preeclampsia 120 or other research specific modules 118, once selected by a user, will generate real-time, easy to read reports of the selected data, including, for example, hemodynamic data, environmental, and demographic data relative to that specific disorder. Furthermore, patient demographic and patient information combined with hemodynamic data, the effects of treatment, and physician intervention data enables quality assurance for future clinical studies and medical research of interest to health care communities.

Research in the research modules 118 and 120 may also incorporate statistical software programs to automatically redefine a treatment based on discovery of relationships within predefined subsets of the data. It is understood by one skilled in the art that the database 110 can similarly incorporate statistical software programs for automatically redefining a treatment based on discovery of relationships with the predefined subsets of the data. The advantages of statistical software programs in the database 110 include larger relational databases for larger matrix analysis, discovery of new relationships from these analyses and therefore better treatments, and determining the best treatment for patients that would be categorized under more than one research module that may individually have differing best treatment outcomes. It is also understood that statistical software programs could be used to generate data in a commercial research portal 126, other communities of interest 128, a preeclampsia community of interest 130, and a larger bio-data warehouse 132 that can ultimately be utilized. As a specific example, it is understood by one skilled in the art that current individual preeclampsia diagnoses (including risk prediction) can be statistically integrated using a statistical software program(s).

Diagnosis (including risk prediction) of preeclampsia is a multivariate process. The Dorland's Illustrated Medical Dictionary (Ref 29^{th} ed, 2000, W.B. Saunders Co, Philadelphia) defines preeclampsia as a complication of pregnancy characterized by hypertension, edema, and/or proteinuria. It is obvious from the definition by one skilled in the art that a comprehensive multivariate analysis for preeclampsia must include variables from hypertension, edema, and proteinuria. Hypertension itself is differentially defined resulting in differences between multiple variables used to define hypertension. It is obvious by one skilled in the art that there are a multitude of factors that can contribute to hypertension and therefore analyzed with multivariate processes to include or exclude these factors. For example, inflammation has been linked to cardiac disease and could be included as a factor that could potentially contribute to hypertension in a multivariate process.

Statistical methods for analyzing multivariate processes continue to progress to more complex methods to include many variables with varying degrees of interdependence. A multivariate process is a process that can be statistically analyzed by any of a variety of multivariate analytical means, such as multivariate analysis, n-dimensional space analysis, principal component analysis (PCA), difference analysis, n-dimensional space analysis, factor analysis, cluster analysis (including hierarchical clustering), and the like. In most preferred embodiments, the analytic tools used are principal component analysis, hierarchical clustering, unsupervised neural networks, ANalysis Of Variance studies (ANOVA), or a combination thereof. More complex tools are Multivariate ANalysis Of Variance (MANOVA) and canonical correlation both involving multiple dependent variables as well as multiple independent variables and are therefore preferred in such complex analyses. MANOVA is appropriate and preferred when the independent variables are nominal or categorical with numerical outcomes. Canonical correlation analysis is appropriate and preferred when the question focuses on the relationship between the set of independent variables and the set of dependent variables with numerical outcomes (Dawson and Trapp, 2004). Multivariate pattern recognition has been successfully used for rheumatoid arthritis (RA) (see U.S. Pat. No. 6,424,859). It is also understood by one skilled in the art that preferred embodiments using a multivariate process include population structure analysis on association studies undertaken to identify genetic variants underlying common human diseases (Helgason A, et al, 2005).

For a more complete analysis of multivariate processes the following textbooks are examples, “Using Multivariate Statistics” (Tabachnick and Fidell, 2006), “Methods of Statistical Data Analysis of Multivariate Observations” (Manly, 2004), “Basic & Clinical Biostatistics”, (Dawson and Trapp, 2004). Software programs for computer integration with multivariate process analysis are also available (e.g., from Partek Inc., St. Peters, Mo., see www.partek.com and StataCorp LP, College Station, Tex., see www.stata.com).

Another advantage of multivariate analysis is the exclusion of outlying data that is statistically unique, i.e., is probably due to a factor(s) that is not currently included in the particular multivariate process. This could allow a more directed search for an unknown variable to be included in a more comprehensive diagnosis.

It is understood by one skilled in the art that analysis of multivariate processes can link diagnosis and treatment methods in relative order of increasing risk for a particular population.

It is further understood by one skilled in the art that an animal model of preeclampsia could potentially be developed or improved (e.g., see U.S. Patent Application Publication No. 2004/0133929) using the results from this invention.

Medical professionals, researchers, non-medical professionals, and health-care providers may also view the data stored in the database 110 by way of remote access provided through the Internet 124. In this embodiment, the system 100 comprises a HIPAA-compliant data feed 122, either wired or wireless, for linking to the Internet 124 or a WAN/LAN, allowing access to the preeclampsia research modules 120, other research modules 118, and other data of the database 110. In this embodiment, specific queries of interest, including for example, queries from the preeclampsia research communities of interest 130, or other communities of interest 128 including the commercial research entities 126 can be used to view selected data of the database 110. Ultimately, hypertension disease data of the database 110 populates the larger bio-data warehouse 132 comprising additional disease information and other biological and disease data.

Graphical User Interface

Referring to FIGS. 5 through 9, one embodiment of the graphical user interface of the system 100 is described. FIG. 5 is a representation of a single screen shot of the patient information form 400 created for the patient session management module 112 permitting entry, review, and revision of the patient information, including for example, name, social security number, patient history, allergies, current medication and referring physician. Button 402 selects a print function for the patient information. Button 404 corresponds to initiating a data acquisition monitoring session via the impedance cardiology device 102. Button 406 allows for a manual session. Button 408 closes the database software. Once a button or tab is selected, the window corresponding to that function is displayed in an overlay fashion over the current user screen. Data is entered via the input devices 111, e.g., keyboard and/or mouse entry into the data fields visible in the window, which correspond directly with data fields of the database 110 that operates in the background. Data fields within the tab windows include stored data in drop-down windows that can be selected and/or are capable of receiving manually entered new data. During a patient management session, a medical professional fills in the data fields of the patient information screen using the input devices 111 to collect the patient information about the patient and the basis of the office session.

As shown in FIG, 5 the patient information screen includes the following: patient number 410, date of session 412, existing patient number 414, name of operator 416, patient first name 418, patient last name 420, patient social security number 422, patient date of birth 424, patient age 426, patient street address 428, patient city of residence 430, patient state of residence 432, patient zip code 434, patient phone number 436, gravidity 438, parity 440, abortions 442, living children 444, whether or not a smoker 446, how many packs a day 448, reason for referral categories including chronic hypertension 450, previous toxemia 452, previous IUGR 454, diabetes 456, renal disease 458, and referral notes 460. Patient history categories include medical 462, pregnancy 464, surgical 466, family 468, and allergies 470. Additional patient information input using this form also includes referring physician/clinic 472, “add physician” button 474, current medications 476 and the following data regarding the pregnancy: pregnancy number 478, MHC protocol 480, due date 482, number of fetuses 484, and out patient number 486. The patient information (or patient data) is stored in the database 110. Once all of the necessary patient information is entered into the database 110 using the patient information form 400, the button 404 is selected to initiate the data acquisition monitoring session.

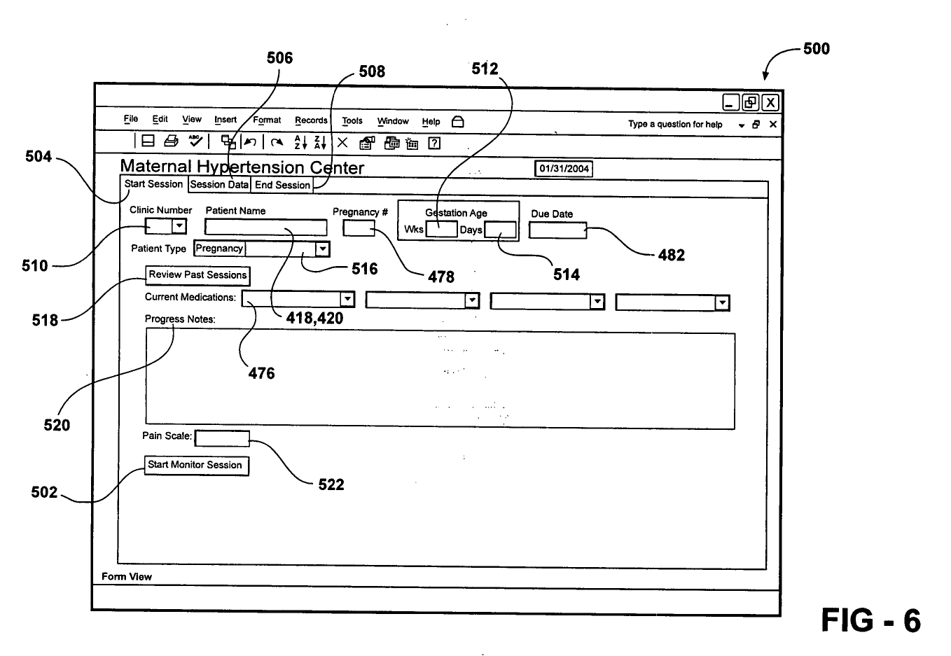

FIG. 6 shows a single screen shot of a first data collection form 500 that is opened when the user selects button 404 from the patient information form 400. The first data collection form 500 prompts the user to update patient information and begin the data collection session via the impedance cardiology device 102. Button 502 starts session monitoring whereby the impedance cardiology device 102 is started and the hemodynamic data is captured by the system 100. The following tabs are selectable by the user: start session tab 504, session data tab 506, end session tab 508. The following data fields are completed by the user: clinic number 510, patient name 418, 420, pregnancy number 478, gestation age (weeks) 512, gestation age (days) 514, due date 482, patient type 516, review past sessions button 518, current medications 476, progress notes 520, and pain scale 522.

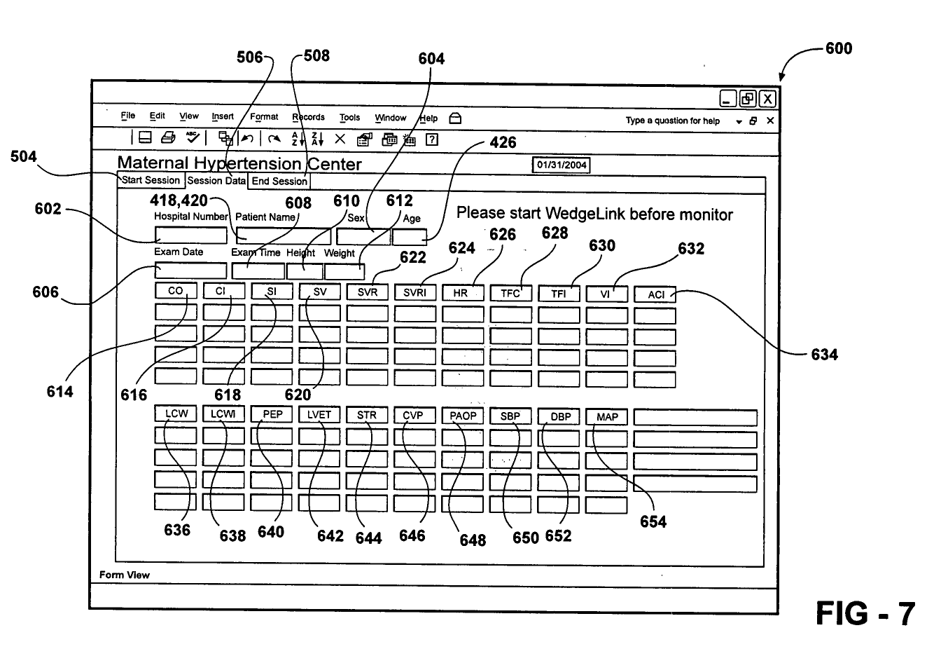

FIG. 7 shows a single user screen shot of a second data collection form 600 that is displayed when the user selects the session data tab 506. The second data collection form 600 displays the hemodynamic data generated by the impedance cardiology device 102 and captured by the system 100. The patient's hemodynamic data are collected while the impedance cardiology device 102 generates the data. This data is combined and associated with the patient information already entered by the medical professional and stored in the database 110. Once the start session data tab 506 is selected, the window displays the following data fields: hospital number 602, patient name 418, 420, sex 604, age 426, exam date 606, exam time 608, height 610, weight 612, CO 614, CI 616, SI 618, SV 620, SVR 622, SVRI 624, HR 626, TFC 628, TFI 630, VI 632, ACI 634, LCW 636, LCWI 638, PEP 640, LVET 642, STR 644, CVP 646, PAOP 648, SBP 650, DBP 652, and MAP 654. For each hemodynamic parameter data field, three sets of data measurements is captured by the system 100 and displayed in real-time on the screen for the user and then averaged by the system 100. The numerical average of the hemodynamic parameter is also displayed on the screen under each data field.

In the preferred embodiment, the system 100 is adapted to check that the hemodynamic data generated by the impedance cardiology device 102 is within user acceptable parameters. As evident to one skilled in the art, the system 100 performs a check on the hemodynamic data using software or logic coded circuitry to determine if an incomplete data transmission has occurred. In the event the impedance cardiology device 102 communicates an incomplete data transmission, the system 100 removes the incomplete data segment and acquires another data set for all selected hemodynamic parameters from the impedance cardiology device 102. The system 100 will repeat the process until a complete data set of all selected hemodynamic parameters is acquired from the impedance cardiology device 102 that is operatively coupled to the system 100. In the preferred embodiment, this is accomplished by simply comparing the number of known hemodynamic parameter data fields that are generated by the impedance cardiology device 102 and configured for transmission to and capture by the software managing the database 110 to the actual number of hemodynamic parameter data fields filled by the database 110. If the numbers do not match, then an error in the transmission has occurred, resulting in the system 100 resetting and re-acquiring the data. Once a complete data set of all selected hemodynamic parameters is captured, the hemodynamic data is ultimately stored in the database 110 in addition to other medical data and patient information acquired by the system 100.

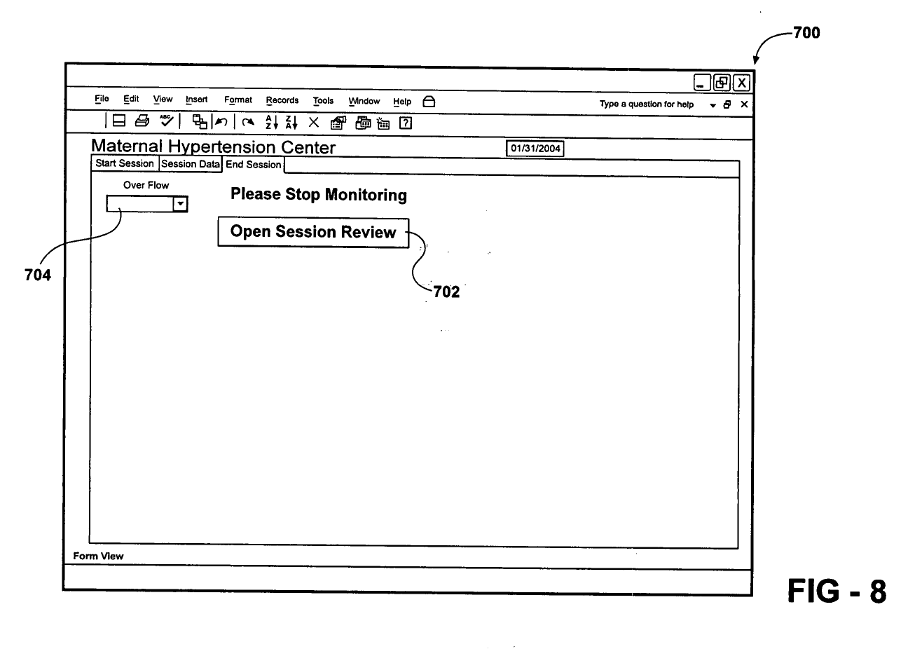

FIG. 8 shows a single screen shot of a third data collection form 700 of the user interface with an open session review button 702 to review a session summary of the data fields and to end the data collection session. The following data fields are completed by the user: over flow data 704. The system 100 also informs the user to stop the data collection (“please stop monitoring”), requiring the user to turn off the impedance cardiology device 102.

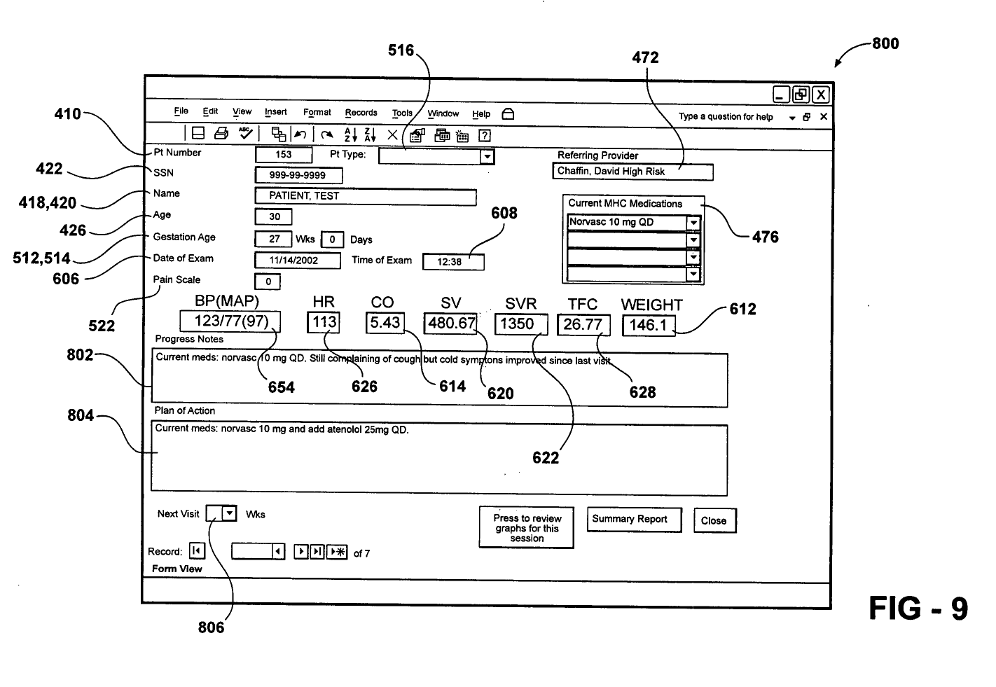

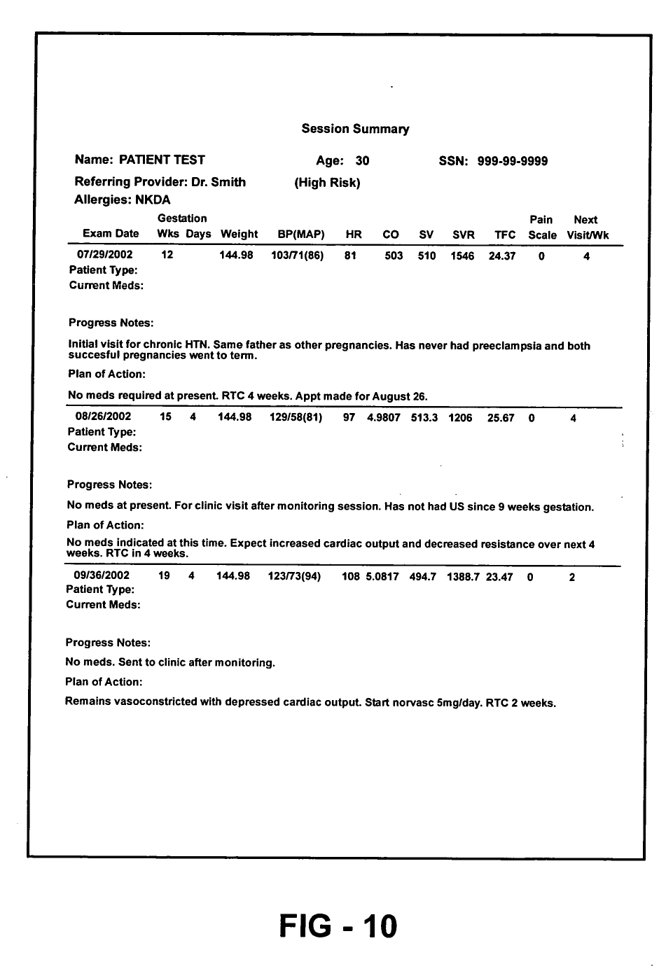

FIG. 9 shows a single screen shot of a fourth data collection form 800 of the user screen interface displaying the session summary review of selected data captured by the system 100. Patient information is displayed which includes patient number 410, patient type 516, patient social security number 422, patient name 418, 420, patient age 426, gestation age (weeks) 512, gestation age (days) 514, date of exam 606, time of exam 608, pain scale 522, referring provider 472, and current medications 476, as well as selected hemodynamic data including blood pressure (MAP) 654, heart rate 626, CO 614, SV 620, SVR 622, TFC 628, and Weight 612. The following data fields are completed by the user: progress notes 802, plan of action 804, and next visit 806, which data is ultimately stored in the database 110. This data is combined and associated with the patient information already entered by the medical professional and stored in the database 110. FIG. 10 shows a sample summary report.

Hypertension Treatment Matrix 300

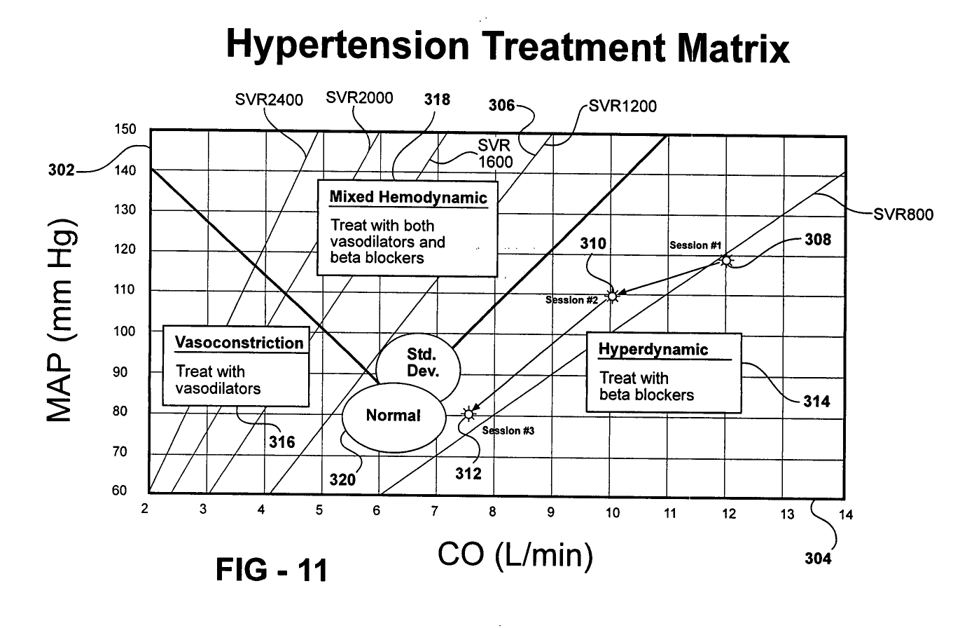

Referring to FIG. 11, in the preferred embodiment of the system 100, a reporting module 116 of the database 110 is used to retrieve at least a predefined subset of the collected hemodynamic data and the patient information from the database 110 and plot the predefined subset on an easy to read hypertension treatment matrix 300. Here, in this embodiment, the predefined subset includes the patient's mean arterial pressure (MAP) 302 plotted against the patient's cardiac output (CO) 304 based upon the hemodynamic data acquired from the impedance cardiology device 102, as stored in the database 110. Additionally, isometric lines of systemic vascular resistance (SVR) 306 are plotted to permit visualization of these hemodynamic variables together, which is necessary for treatment of the hypertensive disorder. The hypertension treatment matrix 300 with the plotted information can be displayed on the display 117 or printed to the printer 119. It should be appreciated by those skilled in the art that the hypertension treatment matrix 300 may be upgraded periodically to reflect changes from the results of multivariate processes.

Reporting of selected hemodynamic data and patient information can alternatively be carried out by any number of methods commonly known to those skilled in the art. During reporting, the data can be reviewed or modified as necessary and additional information regarding the patient session including post session care can be entered by a medical professional using the input devices 111.

In the preferred embodiment, reporting includes displaying the data acquired from prior patient sessions in addition to current hemodynamic data plotted on the hypertension treatment matrix 300 (e.g. a patient's mean arterial pressure 302 plotted against the patient's cardiac output 304). Referring to FIG. 11, for example, three office visits in which hemodynamic data are identified for analysis as Session #1 308, Session #2 310, and Session #3 312, which are plotted on the hypertension treatment matrix 300.

In the preferred embodiment, hypertension treatment is accomplished using standard prescription medication including, for example, atenolol, hydralizine, nifedipine, and isordil to pharmacologically manage at-risk patients based on serial measurements of blood pressure, cardiac output, and systemic vascular resistance. In the preferred embodiment, treatment would begin in the second trimester of pregnancy. In the system 100, the medical professional will analyze the patient information and the hemodynamic data obtained from the impedance cardiology device 102 of the patient. From the data acquired, the choice of anti-hypertensive therapy is based relative to normal maternal hemodynamic parameters 320 represented on the hypertension treatment matrix 300. Treatment is characterized by a vector of change moving a patient's plotted hemodynamic data toward the normal maternal hemodynamic parameters 320 where normal maternal hemodynamic parameters are well discussed in the literature and readily evident to one skilled in the art. Treatment is also based on predefined hypertension categories indicated on the hypertension treatment matrix 300, e.g., hyperdynamic, mixed hemodynamic, or vasoconstriction. Treatment depends on which predefined hypertension category corresponds to the prefined subset of the hemodynamic data of the patient.

In the present invention, if the patient's plotted hemodynamic data places the patient on the right side of the hypertension treatment matrix 300 relative to and not within normal maternal hemodynamic parameters 320, the patient has too much cardiac output and is hyperdynamic. In this event, the patient needs to be managed by a class of medications known as beta blockers that slow the heart rate and reduces the workload of the heart. Commonly, hyperdynamic patients have a CO>8.0 L/min, have a low systemic vascular resistance, often present fatigue and tachycardic symptoms, have a history of preeclampsia with a previous pregnancy and may have a high BMI (>300 lbs). Treatment of a patient determined to be hyperdynamic comprises the prescription of beta blockers such as atenolol and labatelol or combinations of beta blockers and lasix to lower SV. The common side effect of beta blockers is a decrease in fetal weight and fetal growth. In this system 100, the medical professional carefully monitors fetal weight and fetal growth as part of patient case management using the patient case management module 114 and data of fetal weight and growth is ultimately recorded in the database 110 in addition to treatment and prescription recommendations made to the patient.

If the patient's plotted hemodynamic data places the patient on the left side of the hypertension treatment matrix 300 relative to and not within normal maternal hemodynamic parameters 320, the patient is vasoconstricted 316 and needs a drug to relax the vessels and open the vessels. Vasoconstricted 316 patients have CO of 5.0 L/min or less, a MAP>80 mm Hg, and high systemic vascular resistance (SVR). Type 1 diabetics and patients with renal disease are often vasoconstricted patients and usually asymptomatic. Treatment comprises no medications, but close observation if patient is normotensive. If hypertensive, the medical professional may prescribe a class of medications known as vasodilators such as calcium channel blockers, apresoline, or clonidine. The treatment goal is to reduce pressure, increase CO, and decrease the SVR. The end result is that it reduces the workload of the heart so the heart doesn't have to work as hard pushing the blood thru the constricted vessels. Commonly, the side effects of the medication therapy is maternal tachycardia. Therapy may also include low dose beta blockers to control heart rate even if patient does fall into a mixed group discussed below. If the patient is vasoconstricted 316, the medical professional may treat with vasodilators.

If the patient's plotted hemodynamic data identify the patient as mixed hemodynamic 318 but outside normal maternal hemodynamic parameters 320, the patient with mixed hemodynamic parameters may be normotensive with a clinical history or preeclampsia at term, represent no prior history of hypertension but have slowly climbing pressures, or be chronic hypertensive but well controlled prior to pregnancy. Most mixed hyperdynamic patients require combination drug therapy to control their pressure. Cocaine and amphetamine users will fall into the upper left corner of the hypertension treatment matrix 300. If the patient has mixed hemodynamic data outside the normal maternal hemodynamic range 320, the medical professional will treat the patient by prescribing both vasodilators and beta blocker. In this embodiment nifedipine is preferably combined with low dose atenolol resulting in vasodilation and a decrease in BP without maternal tachy. Lasix is rarely used due to decreased cardiac output. In this embodiment, the patient requires close monitoring of fetal growth. Dosing of atenolol and nifedipine may be four times a day. After delivery, this group often remains hypertensive.

The system 100 relates current hemodynamic data to historical hemodynamic data, allowing the medical professional to review past treatment and evaluate prior treatment sessions in relation to normal maternal hemodynamic parameters 320. As a patient's hemodynamic parameters change based on prescribed treatment, as seen for example in sessions #1-3, 308, 310, and 312, the treatment will vary accordingly. The treatment plan and scheduled follow-up is recorded in the database 110.

The system 100 also permits the medical professional to study the relationship between the hemodynamic data and other environmental or health factors including for example, obesity, smoking, and family history including inflammation. The study of relationships can include use of statistical software programs and can involve very large matrices. In the preferred embodiment, blood pressure, cardiac output, and systemic vascular resistance are measured using thoracic electric impedance plethysmography. Patients with hyperdynamic or mixed vasoconstrictive-hyperdynamic measurements at a gestational age of less than 24 weeks may be treated with atenolol. Vasodilators may be added for systemic vascular resistance>1100 dyne*sec*cm−5. Patients are followed on a regular basis with medication dosages adjusted to attempt to achieve normal maternal hemodynamic parameters 320.

The system 100 enables medical professionals to identify hemodynamic problems and intervene early in the pregnancy. Early intervention with atenolol in an at-risk population with abnormal hemodynamic data results in a low rate of early hypertensive complications with no increase in growth restriction of the fetus.

In the preferred embodiment, the system 100 enables a medical professional to remotely evaluate, monitor, diagnose and treat or manage preeclampsia and other hypertensive disorders. This is accomplished by allowing medical professionals to access data including the medical data and the patient information from the database 110 either directly, or through a WAN/LAN, or the Internet 124. In this instance, the system 100 comprises a secure web or network system protocol as would be evident to one skilled in the art.

A number of computer platforms can be used to perform the necessary processes of the system 100 including acquiring and storing the data in the database 110. All data acquired ultimately populates the database 110 wherein it can be processed and sequenced, selected, and loaded into specific research modules 118, 120 or reviewed as part of the patient case management module 114, reporting module 116, or linked to the Internet 124 or other network. The invention provides a method of screening data by HIPAA compliant filters to protect selected patient information. For the purposes herein, a network may be any one of a number of conventional network systems, including a wide area network (WAN) or a local area network (LAN), as is known in the art, and may be wired or wireless.

In the preferred embodiment, the system 100 includes network functionality by using well-known formats (e.g. URL). All computers herein include the hardware necessary for running software to access the database 110 for processing and to provide an input interface and display for reporting. In the preferred embodiment, the software running on the computer supports the World Wide Web protocol for providing page data between the Internet 124 and the database 110 including the HIPAA-compliant data feed 122. Server environment, database servers, and networks are well documented in the technical, trade, and patent literature.

As would be obvious to one skilled in the art, the present invention incorporates Internet 124 applications including executable code and configuration files permitting remote users to interface with the database 110 and construct requests for retrieving data from the database 110, including point and click menus, scroll bars and conventionally employed graphical user interfaces. The system 100 may employ Hypertext Mark-up Language (HTML pages) and employ TCP/IP protocol. It should be noted that if the content of the database 110 is to remain private, a firewall may be used to preserve in confidence the contents of the database 110.

Obviously, many modifications and variations of the present invention are possible in light of the above teachings. Furthermore, the patient information disclosed herein, e.g., information regarding medical treatment, medication, dosages, etc., should in no way be considered to be an offer of medical advice. The information disclosed herein is provided for informational purposes only.

### REFERENCES

Dawson B and Trapp RG, 2004, “Basic & Clinical Biostatistics”, Lange Medical Books/McGraw-Hill Medical Publishing Division, New York, 4^{th} ed, Chapter 10, Statistical Methods for Multiple Variables.

Grant S F, et al, 2006, Variant of transcription factor 7-like 2 (TCF7L2) gene confers risk of type 2 diabetes. Nat. Genet. 38(3):320-3.

Helgason A, Yngvadottir B, Hrafnkelsson B, Gulcher J, and Stefansson K (2005) An Icelandic example of the impact of population structure on association studies. Nat. Genet. 37(1):90-5.

Manly B F J, 2004 “Methods of Statistical Data Analysis of Multivariate Observations” Chapman & Hall/CRC 3rd ed.

Tabachnick B G and Fidell L S, 2006 “Using Multivariate Statistics” Allyn & Bacon, 5^{th} ed.

What is claimed is:

1. A method for treating hypertension, comprising;
monitoring at least one hemodynamic parameter of a patient,
collecting data related to the at least one monitored hemodynamic parameter of the patient,
storing the collected data in a database,
transferring patient information of the patient to the database and correlating the collected data to the patient information,
retrieving at least a predefined subset of the collected data and the transferred patient information, and
automatically determining a treatment based on the retrieved subset.

2. A method as set forth in claim 1 wherein automatically determining the treatment includes comparing the retrieved subset to a hypertension treatment matrix and indicating a predefined hypertension category corresponding to the retrieved subset.

3. A method as set forth in claim 2 wherein comparing the retrieved subset to the hypertension treatment matrix includes plotting the retrieved subset on the hypertension treatment matrix.

4. A method as set forth in claim 3 including prescribing a class of medication based on the predefined hypertension category corresponding to the retrieved subset.

5. A method as set forth in claim 2 including modifying the hypertension treatment matrix using statistical methods for analyzing multivariate processes.

6. A method as set forth in claim 1 including;
monitoring a plurality of hemodynamic parameters of a plurality of patients,
collecting data related to the plurality of monitored hemodynamic parameters of the plurality of patients,
storing the collected data in the database, and
transferring patient information of the plurality of patients to the database and correlating the collected data to the patient information for each of the plurality of patients.

7. A method as set forth in claim 6 including providing remote access to the database such that users can retrieve at least portions of the collected data and the patient information.

8. A method as set forth in claim 7 wherein providing remote access to the database includes complying with HIPAA requirements.

9. A method as set forth in claim 6 wherein collecting data related to the plurality of monitored hemodynamic parameters of the plurality of patients includes collecting data related to the plurality of monitored hemodynamic parameters of the plurality of patients over a network.

10. A method as set forth in claim 9 wherein the network is one of a wide area network (WAN) or a local area network (LAN).

11. A method for treating a medical disorder, comprising;
monitoring at least one medical parameter of a patient,
collecting data related to the at least one monitored medical parameter of the patient,
storing the collected data in a database,
transferring patient information of the patient to the database and correlating the collected data to the patient information,
retrieving at least a predefined subset of the collected data and the transferred patient information, and
automatically determining a treatment based on the retrieved subset.

12. A method as set forth in claim 11 wherein automatically determining a treatment includes incorporating statistical methods for analyzing multivariate processes.

13. A system for treating a medical disorder, comprising;
a first data collection device for monitoring at least one medical parameter of a patient and collecting data related to the at least one medical parameter of the patient,
a database for storing the collected data,
an input device in communication with said database for transferring patient information of the patient to said database wherein said database correlates the collected data to the patient information of the patient for purposes of treating the patient, and
a reporting module in communication with said database for retrieving at least a predefined subset of the collected data and the patient information and automatically determining a treatment for the medical disorder based on the predefined subset.

14. A system as set forth in claim 13 including a plurality of sensors coupled to said first data collection device for non-invasively monitoring a plurality of medical parameters of the patient.

15. A system as set forth in claim 13 including a research module in communication with said database for allowing a user to retrieve at least a portion of the collected data.

16. A system as set forth in claim 13 including a second data collection device remotely located relative to said first data collection device for monitoring at least one medical parameter of a second patient and collecting data related to the at least one medical parameter of the second patient.

17. A system as set forth in claim 16 wherein said database is configured for storing the collected data related to the at least one medical parameter of the second patient.

18. A system as set forth in claim 17 including a network for providing communication between said second data collection device and said database.

19. A system as set forth in claim 18 wherein said network is one of a wide area network (WAN) or local area network (LAN).

20. A system as set forth in claim 19 including a HIPAA-compliant data feed for remotely accessing said database.

21. A system for treating hypertension, comprising;
a plurality of data collection devices for monitoring hemodynamic parameters of a plurality of patients during patient sessions and collecting data corresponding to the hemodynamic parameters during each of the patient sessions,
a centralized database for storing the collected data,
at least one input device in communication with said centralized database for transferring patient information from each of the plurality of patients to said centralized database during each of the patient sessions wherein said database correlates the collected data to the patient information for the purpose of treating the patients for hypertension, and
a reporting module in communication with said database for retrieving at least a predefined subset of the collected data and the patient information for each of the patients and automatically determining a treatment for each of the patients based on the predefined subset.

22. A system as set forth in claim 21 including a network for providing communication between said data collection devices and said centralized database.

23. A system as set forth in claim 22 wherein said network is one of a wide area network (WAN) or local area network (LAN).
